(19) United States
(12) Patent Application Publication
(10) Pub. No.: US 2004/0143543 A1
(43) Pub. Date: Jul. 22, 2004

(54) Electronic real estate settlement

(76) Inventor: Robert P. Goldman, Bethesda, MD (US)

Correspondence Address: STAMATIOS MYLONAKIS, 7009 CASHELL MANOR COURT, DERWOOD, MD, 20855-1201, US

(21) Appl. No.: 10/346,090

(22) Filed: Jan. 17, 2003

(51) Int. Cl. G06F 17/60

(52) U.S. Cl. 705/38

(57) ABSTRACT

A method for carrying out a real estate settlement using electronic documents, substantially in the absence of paper, where substantially all real estate settlement papers are provided in electronic format for review, signing, transmitting and storing.

### BACKGROUND OF THE INVENTION

1. Field of the Invention

The present invention is directed to a method for carrying out a real estate settlement electronically, where forms required to fill in for the settlement are in electronic format and are filled in, transmitted, if necessary, and stored in electronic format.

2. Discussion of the Related Art

Currently, all real estate settlement papers, such as those designated under

Real Estate designated under Real Estate Settlement Procedures Act Settlement Procedures Act (RESPA), including HUD-1 settlement sheet, Note, Deed, Deed of Trust (known also as Mortgage), Right of Rescission for a refinance and all ancillary documents are paper forms, filled in manually, reviewed and signed in multiple copies by the parties involved in the transaction, such as the Borrower, the Seller and Purchaser; the signature of the Borrower, Seller or Purchaser is verified by the signature of a notary public and distributed as hard copies to the Borrower, the Seller and the Purchaser; the Lender; the settlement Attorney or Agent; and the Courthouse. The present invention eliminates the need of substantially all the paper by providing a method for electronic real estate settlement substantially in the absence of any paperwork.

### SUMMARY OF THE INVENTION

It is an object of the present invention to provide an improved method for a real estate settlement, substantially in the absence of paper documents, where the required forms are filled in and the resulting documents are transmitted and stored electronically.

### DESCRIPTION OF THE PREFERRED EMBODIMENTS

In one embodiment of the present invention substantially all real estate settlement papers, such as those designated under RESPA, including but not limited to HUD-1 settlement sheet, Note, Deed, Deed of Trust (known also as Mortgage), Right of Rescission for a refinance, and all ancillary documents related to a real estate settlement, such as Addendum Page To HUD-1, Contract/Correction Agreement Limited Power Of Attorney, Owners Affidavit, Survey Affidavit, Compliance Agreement, Owner/Seller Affidavit, Escrow Agreement, Affidavit For Acknowledgment Of Re-Recording, Attorney Representation Letter, Borrower/Seller/Settlement Agent Funding Policy Affidavit, Borrower Certificate/Affidavit, Buydown Agreement, Compliance Agreement, Disclosure Statement, Escrow Waiver Agreement, FHA Firm Commitment, Final Signed 1003 Application, First Lien Title Clearance Letter, First Payment Letter, Flood Hazard Notice, GNMA Refinance Certification, HUD-1 Borrower/Seller/Agent Certification, Initial HUD-1 Escrow Statement, IRS Form 4506, IRS Form 8821, IRS Form W-9 For All Borrowers, Itemization Of Amount Financed, Deed Of Trust Rider(S), Name Affidavits For All Borrowers, Notice Of Assignment Of Servicing Notice Of Right To Cancel Notice To Homeowner, Notice To Mortgagor Relating To Prepayment, Tax Information Sheet, Truth-In-Lending Statement, VA 26-1820, VA Collection Policy Notice, Warranty Of Completion, Consolidated Note, Original Note, Mortgagor's Affidavit, Title Insurance, Survey, FHA HD-1 Addendum, PMI Disclosure, Tax Escrow Designation, Tax Information Sheet And Net Funding Sheet, Authorization And Disbursement, Initial Escrow/Impound-Aggregate Disclosure, Repair Escrow Agreement, W-9's, Notice Of Right To Cancel, Final Truth-In-Lending, Certification Of Occupancy, Monthly Payment Acknowledgement, Occupancy Affidavit, 1040 Form/4506 Form, Smoke Alarm Affidavit, Property Insurance Account Disclosure, Notice To Homeowner, Fraud Notice, Borrower Notification, Criminal Code 1010, VA Disbursement Certificate, Verification Of VA Benefit Form 26-8937, Veterans And Lender Statement, Undertaking And Indemnity, Original Security Agreement, Original Recognition Agreement, Original Property Lease/Occupancy Agreement, Stack Shares Or Membership Certificate Evidencing Ownership, Original Executed Copy Of UCC-1 Financing Statement, UCC-1 Filing Authentication Agreement, Original Executed Copy Of UCC-3, Original Stock Power, Original Assignment Of Property Leas, Restricted Occupancy Certificate, Co-Op Board Supplement, Co-Op Loan Collateral Receipt, Letter Agreement, Affidavit Of Purchaser, Affidavit Of Seller, First Lien Registration Certificate, Corp. Maintenance/Assessment Letter, Good Faith Estimate, Rate Lock-In, Commitment Letter/Addendum, Advance Disclosure Statement, Broker Letter And Copy Of Check, Escrow Waiver, State Required Disclosures, Funding/Wiring Instructions, Name Affidavit, Specific Power Of Attorney, Assignment Of Security Instrument, Security Instrument, Loan Modification Agreement, Tax Information Sheet Signed By Closing Agent, Tax Authorization Letter, Title Binder/Policy, Final Typed Loan Application, Servicing Transfer Disclosure, Adjustable Rate Mortgage Disclosure, Verification Of Deposit Gift Letter, Affordable Housing Mortgage Credit Certificate Worksheet, Affordable Housing Mortgage Credit Certificate, W-4 IRS Worksheet, Sales Contract, Good Faith Estimate, W-9 For Primary Borrower, Telephone Employment Conformation Form, are electronically prepared and shown to at least one of a Borrower, a Seller and a Purchaser, on a computer monitor; after the Borrower, Seller or Purchaser has reviewed all of the documents and accepts the content of the documents, the Borrower, Seller or Purchaser confirms his/her agreement with the content of the documents. The conformation is made electronically, preferably by touching a finalization button on the computer screen, which locks the document from further modification, that is, allowing no further changes to the documents except for entering the signatures of the Borrower, Seller or Purchaser; the Settlement Attorney or Agent; and the Notary, including relevant notary information. Subsequently, the Borrower, Seller or Purchaser signs his or her name on an electronic pad. A notary public also sings his/her name and fills in his/her notary information on the electronic pad. The program fills the Borrower's, Seller's or Purchaser's and Notary's names and signatures onto the documents shown on the screen and creates a Compact Disc configured for Read Only Memory (CD-ROM), that is, a CD which is write protected (a non-rewritable CD), for the Borrower, Seller or Purchaser to take with him/her and one marked “original” for the Lender. A third copy of the CD-ROM is also created for the settlement Attorney or Agent. One original of the Deed, and/or Deed of Trust are printed out from the Lender's original CD-ROM to be recorded at the courthouse. In accordance with a preferred embodiment of the present invention any party can print out copies of the documents, but only the original noted CD-ROM of the Lender prints documents marked as “Original”. The Borrower's, Seller's or Purchaser's, and Settlement Agent's copies are noted as “Certified True Copies”. Security is maintained in the settlement by the mandatory presence of a Notary during the settlement. Further, “HUD-1 settlement sheet” as used herein is a term recognized in the art of Real Estate; the HUD-1 settlement sheet itemizes the services provided and fees charged to the Borrower, Seller or Purchaser.

In another embodiment, the computer is configured for a network connection, where the network is an intranet or the Internet and the settlement is carried out via the intranet connection, where the notary is present at the computer terminal with the Borrower, Seller or Purchaser to input his or her information and confirm the signature of the Borrower, Seller or Purchaser. All of the information is securely transmitted back over the internet to the Settlement Agent whose computer creates the CD-ROM. Preferably, a copy of the electronic documents of the settlement is held for a specific period on the Borrower's, Seller's or Purchaser's computer or accessed through a network site until the CD-ROM is received by the Borrower, Seller or Purchaser. It is understood that the Deed, and or the Deed of Trust can be transmitted to the Courthouse via the Internet when the Courts are able to accept recordings that way.

In a preferred embodiment the electronic documents of the settlement are created and saved on a CD-ROM in Portable Document Format (PDF) files, which can be viewed by any computer with a CD-ROM reader and a basic interpretive program such as ADOBE ACROBAT READER which is available through a free download from the Internet.

In another preferred embodiment of the present invention the settlement documents include an identification verification document of the Borrower, Seller or Purchaser. The identification document includes, but is not limited to, a scanned photo identification (ID), such as a driver's license, a passport or other official identification; a digital photo image, preferably taken at the time of the settlement; a thumbprint; an eye retina image; a digital voice recording or a combination of any of the above verification documents. Any other technology that might develop in the future for identification to be used in electronic data processing and transmission can be used in accordance with the present invention. However, based on currently available technology, it is preferred that the identification of the Borrower, Seller or Purchaser is verified by scanning a photo ID or by a digital photo along with a recorded voice message and the signature of the Borrower, Seller or Purchaser. By way of a not limiting example the voice message can state:

“I swear under the penalties of perjury that I, ______, am the person aforementioned in the loan documentation and hereby voluntarily give my signature, seal and approval to said documentation and agree to be bound by the terms herein,”

Thus, the method of the present invention creates a legally viable format for real estate loans substantially in the absence of the huge amount of paper currently required.

Having generally described this invention, a further understanding can be obtained by reference to certain specific examples which are provided herein for purposes of illustration only and are not intended to be limiting unless otherwise specified.

Obviously, numerous modifications and variations of the present invention are possible in light of the above teachings. It is therefore to be understood that within the scope of the appended claims, the invention may be practiced otherwise than as specifically described herein.

1. A method for carrying out a real estate settlement electronically comprising,
storing in a computer at least one electronic form required for settlement;
filling in electronically said form with information pertaining to at least one Borrower, Seller or Purchaser to form an electronic document;
accepting and confirming said information on said document by said Borrower, Seller or Purchaser by placing his/her signature on an electronic pad configured to transmit information to the computer;
transmitting said signature on to a pre-assigned location in the document;
confirming said client's signature by a notary public by placing his/her signature and filling in his/her notary information on the electronic pad;
transmitting said signature and said notary information to a pre-assigned location in the electronic document; and
creating at least one compact disk containing the information in the document.

2. The method of claim 1, wherein said document is at least one document designated under a Real Estate Settlement Procedures Act.

3. The method of claim 1, wherein said document is selected from the group consisting of a HUD-1 settlement sheet, a Note, a Deed, Deed of Trust, a Right of Rescission for a refinance, any ancillary document relating to a real estate settlement and any combination thereof.

4. The method of claim 1, wherein said form is in PDF format.

5. The method of claim 1, wherein the information in said document is confirmed by the Borrower, Seller or Purchaser by touching a finalization button on the computer to lock the document from further modification.

6. The method of claim 1, wherein one CD is created by the computer containing the documents of the settlement, said disk is marked Original CD and said disk is maintained by a Lender.

7. The method of claim 6, wherein said Original CD is configured to print a paper document marked Original.

8. The method of claim 6, wherein each of Borrower, Seller or Purchaser and the settlement Agent receives a copy of said CD marked as Copy CD.

9. The method of claim 8, wherein said Copy CD is configured to print a paper document marked True Copy.

10. The method of claim 3, wherein one original of at least one selected from the group consisting of said Deed and Deed of Trust are transmitted to a Courthouse.

11. The method of claim 1, wherein said settlement is carried out via the internet,

12. The method of claim 1, further comprising a Borrower, Seller or Purchaser identification verification document selected from the group consisting of a scanned photo ID, a digital photo image, a thumbprint, an eye retina image, a digital voice recording and a combination thereof.
